(19) United States
(12) Patent Application Publication
(10) Pub. No.: US 2002/0070646 A1
(43) Pub. Date: Jun. 13, 2002

(54) Enhanced thermal expansion divider layers for a high efficiency, extended life spark plug

(76) Inventor: Randolph Kwok-Kin Chiu, Davison, MI (US)

Correspondence Address: DELPHI TECHNOLOGIES, INC., Lagal Staff, Mail Code: 480-414-420, P.O. Box 5052, Troy, MI, 48007-5052, US

(21) Appl. No.: 09/735,179

(22) Filed: Dec. 12, 2000

(51) Int. Cl. H01T 13/20

(52) U.S. Cl. 313/141; 313/140

(57) ABSTRACT

The spark plug assembly comprises a pair of electrodes, a pair of resistance welded thermal expansion divider layers affixed to the electrodes, and a pair of resistance welded firing tips affixed to the thermal expansion divider layers, such that the firing tips are coaxially aligned to form a spark gap. The thermal expansion divider layers further comprise an electrically conductive alloy comprising a combination of metals selected from the group consisting of iron, chromium, aluminum, manganese, and silicon. The thermal expansion divider layer reduces thermal stress fatigue, and eliminates the premature failure of the firing tips due to cracking, peeling and/or spalling.

### TECHNICAL FIELD

This disclosure relates to spark plugs and, more particularly, to spark plugs for spark ignition engines.

### BACKGROUND

Conventional spark plugs are continually being improved to extend their useful lifespan. Historically, spark plug electrodes typically utilized intermediate layers of material to prevent firing tips from cracking, peeling, or spalling, and falling off the spark plug electrode. For instance, U.S. Pat. No. 4,670,684 to Kagawa et al., which disclose using an intermediate layer of platinum-nickel alloy containing 10 to 60% by weight of nickel, and the balance platinum, within a chip welded to the spark discharge surface of the electrode.

However, the firing tip also comprises a platinum-nickel alloy, such that there exists no appreciable difference in the coefficient of thermal expansion between the firing tips, and intermediate layer. When this welded combination is thermal cycled from 300° C. to 830° C., the firing tip will crack along the weld bond and fall off the electrode thereby rendering the spark plug useless.

Consequently, there exists a need for a spark plug that extends the useful lifespan of existing conventional spark plugs.

### SUMMARY

The drawbacks and disadvantages of the prior art are overcome by the embodiment of the spark plug, and methods for fabricating firing tips for a spark plug described herein. A spark plug assembly comprises an insulator body disposed within a shell. A ground terminal comprising a ground electrode extends from the shell, while a center terminal comprising a center electrode is disposed within the insulator body. Disposed on the center electrode, as well as the ground electrode is a resistance welded thermal expansion divider layer. Furthermore, a resistance welded firing tip is disposed on the thermal expansion divider layer. The firing tips are coaxially aligned to define a spark gap.

The method for fabricating a firing tip for a spark plug assembly comprises resistance welding a thermal expansion divider layer to an electrode. An electrically conductive wire is resistance welded to the thermal expansion divider layer. The electrically conductive wire is cut to form an initial tip. The initial tip is coined to form the firing tip.

The method for fabricating a firing tip for a spark plug electrode comprises resistance welding the electrically conductive wire to the electrode. The electrically conductive wire is coined to form a thermal expansion divider layer. A second electrically conductive wire is resistance welded to the thermal expansion divider layer. The second electrically conductive wire is cut and coined to form the firing tip.

### BRIEF DESCRIPTION OF THE DRAWINGS

Referring now to the figures, which are meant to be exemplary, not limiting, and wherein like elements are numbered alike in the following Figures.

FIG. 1 illustrates a partial cross-sectional view of an embodiment of the spark plug assembly employing an embodiment of a thermal expansion divider layer.

FIGS. 2-5 illustrate the steps in the fabrication process of the thermal expansion divider layer of the center electrode.

FIGS. 6-10 illustrate the steps in the fabrication process of the thermal expansion divider layer of the ground electrode.

FIG. 11 illustrates a partial cross-sectional view of an embodiment of a spark plug assembly employing an alternative embodiment of the thermal expansion divider layer.

FIGS. 12-16 illustrate the steps in the fabrication process of the thermal expansion divider layer of the center electrode; and

FIGS. 17-21 illustrate the steps in the fabrication process of the thermal expansion divider layer of the ground electrode.

### DESCRIPTION OF THE PREFERRED EMBODIMENT

A spark plug assembly comprises a shell that houses an insulator body. The insulator body electrically isolates a center terminal from a ground terminal. The center terminal includes a center electrode, which is disposed within a passage in the insulator body, while the ground terminal includes an L-shaped ground electrode, which is attached, typically by welding, to the shell. The center electrode and insulator body protrude beyond an end of the shell, while the center electrode further protrudes beyond the insulator body to include an thermal expansion divider layer, and a firing tip having a firing surface. The ground electrode also includes a thermal expansion divider layer, and a firing tip having a firing surface.

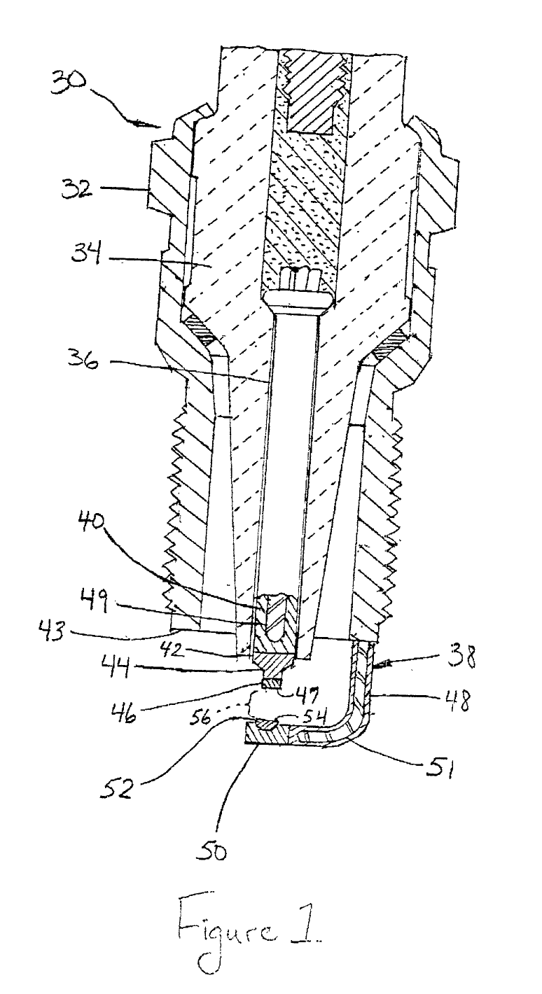

FIG. 1 illustrates an embodiment of a spark plug assembly. A spark plug assembly 30 comprises a shell 32 that houses an insulator body 34, which electrically isolates a center terminal 36 from a ground terminal 38. The center terminal 36 further comprises a center electrode 40 disposed within at least a portion of a first end 42 of a passage in the insulator body 34. The center electrode 40 and insulator body 34 protrude outward from the first end 43 of the shell 32, and center electrode 40 protrudes outward even further from the insulator body 34 to define a thermal expansion divider layer 44. Affixed to the thermal expansion divider layer 44 is a firing tip 46 that includes a firing surface 47.

Disposed opposite the firing tip 46 is a second firing tip 52 affixed to a thermal expansion divider layer 50, and attached to m L-shaped ground electrode 48 that extends from and is contiguous to the first end 43 of the shell 32. The firing tip 52 further defines a firing surface 54. The second firing tip 52 is coaxially aligned with the firing tip 46, and located between the center and ground electrodes 40 and 48. The space formed between the firing tips 46 and 52 further defines a spark gap 56.

The shell 32 comprises a ferrous material, and the like, or an alloy comprising a ferrous material. Some possible ferrous materials comprise a stainless steel, for example, the 400-Series stainless steels (e.g., SS-409, SS-439, SS-441, and the like), the 300-Series stainless steels (e.g., SS-304, SS-316, and the like), the 1000 Series stainless steels (e.g., SAE-1008., SAE-1010, and the like), as well as alloys and mixtures comprising at least ore of the foregoing stainless steels. Possible metals which can be alloyed or combined with the stainless steels comprise, for example, nickel, nickel plating, and the like.

The center electrode 40 and ground electrode 48 can comprise an electrically conductive material disposed about a thermally conductive core 49, 51, respectively. The electrically conductive material comprises a metal or alloy, and the like, or combinations comprising at least one of the foregoing. For example, the electrically conductive material can be a transition metal and alloys thereof, such as nickel, chromium, iron, manganese, silicon, and combinations and alloys comprising at least one of the foregoing materials with “INCONEL 600” preferred. INCONEL 600 is commercially available from Gibbs Wire & Steel Co., Inc, and possesses a coefficient of thermal expansion of about 16.7 um/m-° C. at about 900° C.

The thermally conductive cores 49, 51 of both the center and ground electrodes comprises a thermally conductive material, which lowers the operating temperature of the electrodes during operation under conditions such as spark ignition engine conditions, that can comprise a thermally conductive metals, alloys, mixtures, and combinations comprising at least one of the foregoing, and the like. For example, a thermally conductive material comprising a transition metal can be employed, such as silver, copper, and the like, as well as alloys, mixtures and combinations compromising at least one of the foregoing, and the like.

A pair of thermal expansion divider layers 44 and 50 are affixed to the center and ground electrodes 40 and 48, respectively, by any known techniques such as a welding operation, with a resistance welding operation preferred, and serving as a base for the firing tips 46 and 52. The thermal expansion divider layers 44 and 50 comprise an electrically conductive electrode material such as an electrically conductive metal. Possible materials include iron, chromium, aluminum, manganese, silicon, as well as, alloys, and mixtures comprising at least one of the foregoing materials, with alloys comprising iron-chromium-aluminum preferred, and an alloy comprising iron, up to about 15% or greater by weight of chromium, and up to about 4% or greater by weight of aluminum (also known as Fe-15Cr-4Al) especially preferred. The latter iron alloy possesses a coefficient of thermal expansion of about 13.7 um/m-° C. at about 900° C.

The firing tips 46 and 52 comprise an electrically conductive material affixed to the thermal expansion divider layers 44 and 50. Possible materials include noble metals such as platinum, palladium, iridium, rhodium, other noble metals, as well as alloys and mixtures, and combinations comprising at least one the foregoing, and the like, with platinum, iridium, or a platinum-iridium alloy preferred. These electrically conductive materials typically possess a coefficient of thermal expansion value in the range of about 10.0 um/m-° C. to about 8.5 um/m-° C., at about 900° C.

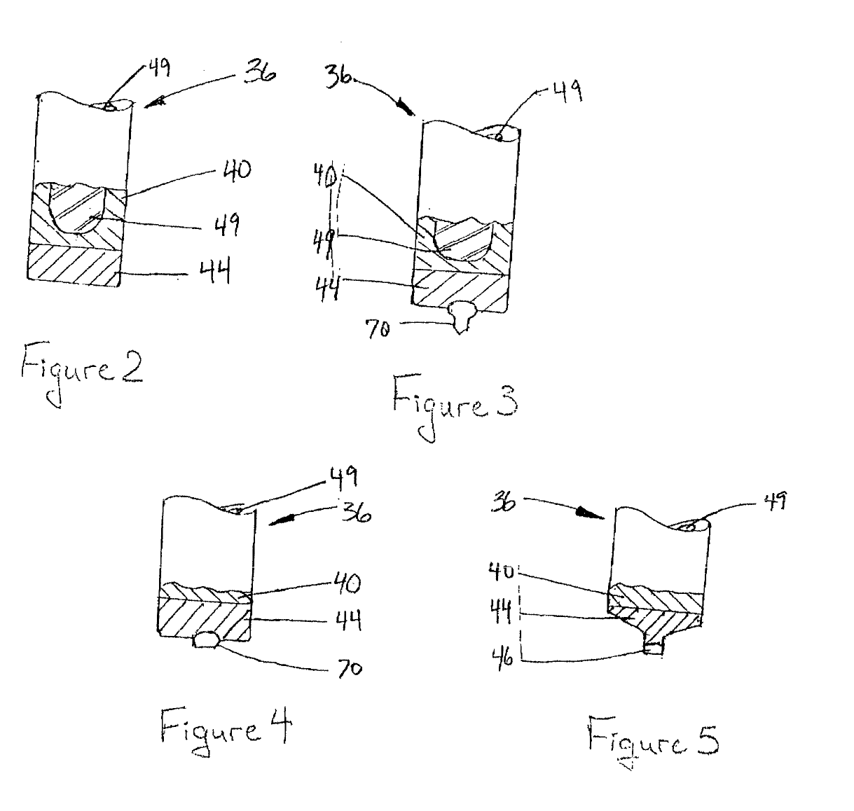

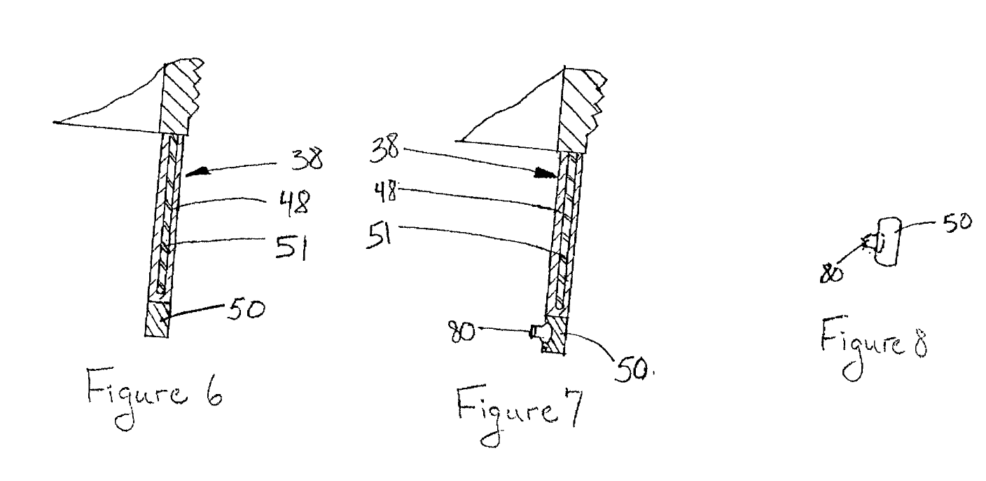

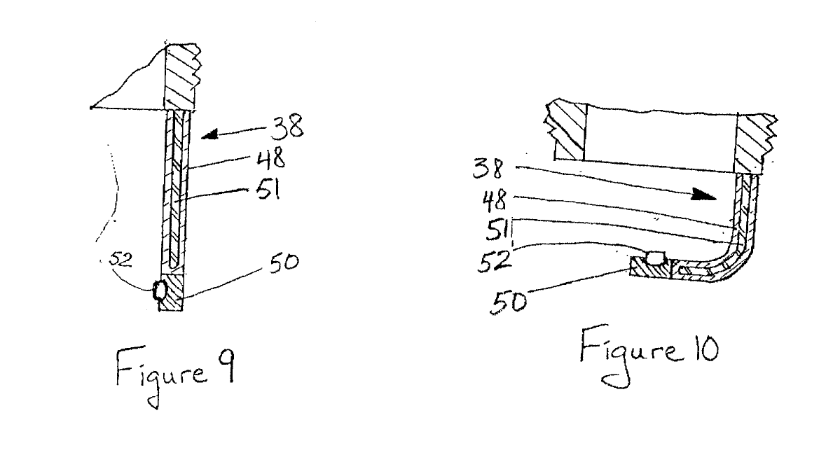

The thermal expansion divider layers 44, 50 of the spark plug assembly 30 can be manufactured as illustrated in FIGS. 2 through 5, and FIGS. 6 through 9. More specifically, FIGS. 2 through 5 can illustrate the fabrication of the center electrode's thermal expansion divider layer, and firing tip. A thermal expansion divider layer 44, having a geometry such as an annular shaped disc, or a flat planar bar, can be resistance welded to the base of the center electrode 40. The resulting thermal expansion divider layer 44 can have a diameter up to about 3.00 mm, with up to about 2.50 mm preferred. A continuous wire feeding and resistance welding procedure can weld a wire comprising an electrically conductive material, and having a diameter of up to about 1.50 mm, with up to about 1.00 mm preferred, and about 0.45 mm to about 0.75 mm especially preferred, to the base of the thermal expansion divider layer 44. The wire can be subsequently cut to an appropriate length to form an initial firing tip 70 (See FIG. 3). The initial firing tip 70 can be coined, or flattened, to create a firing tip 46 having a mushroomed shaped surface, and a diameter up to about 1.50 mm, with up to about 1.00 mm preferred, and a height of up to about 0.75 mm, with up to about 0.50 mm preferred. (See FIG. 4). The firing tip, and a portion of the center electrode, can be sized, or narrowed, to a diameter of about 0.50 mm to about 1.00 mm, and a height of about 0.50 mm to about 1.00 mm (See FIG. 5). The dimensions of each component are ultimately dependent upon the overall size of the spark plug assembly, and therefore may vary substantially with each particular application.

FIGS. 6 through 10 can illustrate the fabrication of the ground electrode's thermal expansion divider layer, and firing tip. A thermal expansion divider layer 50, having a geometry such as an annular shaped disc, or a flat, planar bar, can be resistance welded to the base of the ground electrode (See FIG. 6). The resulting thermal expansion divider layer50 cart have a rectangular cross-section of about 1.00 mm by about 2.00 mm, to about 1.65 mm by about 3.00 mm, with about 1.50 mm by about 2.80 mm preferred. A continuous wire feeding and resistance welding procedure can weld a wire comprising an electrically conductive material, and having a diameter of up to about 1.50 mm, with up to about 1.00 mm preferred, and about 0.45 mm to about 0.75 mm especially preferred, to the thermal expansion divider layer 50. The wire can be held in place by any known technique such as, a collet, and the like. The resistance welded wire can subsequently be cut to an appropriate length to form an initial firing tip 80 (See FIGS. 7, 8). The initial firing tip 80 can be coined, or flattened, to form a firing tip 52 having a mushroomed shaped surface, and a diameter up to about 2.00 mm, with up to about 1.00 mm preferred, and up to about 0.90 mm especially preferred, and a height of up to about 1.00 mm, with up to about 0.75 mm preferred, and up to about 0.50 mm especially preferred (See FIG. 9). Referring specifically now to FIG. 10, the ground terminal 3 8 can be bent by any known technique so that the firing tip 52 is coaxially aligned with the firing tip 46 of the center electrode 40, and the spark gap 56 is also formed simultaneously (See FIG. 1). The dimensions of each component are ultimately dependent upon the overall size of the spark plug assembly, and therefore may vary substantially with each particular application. The thermal expansion divider layer illustrated in FIG. 1 can preferably be utilized with conventional engine applications.

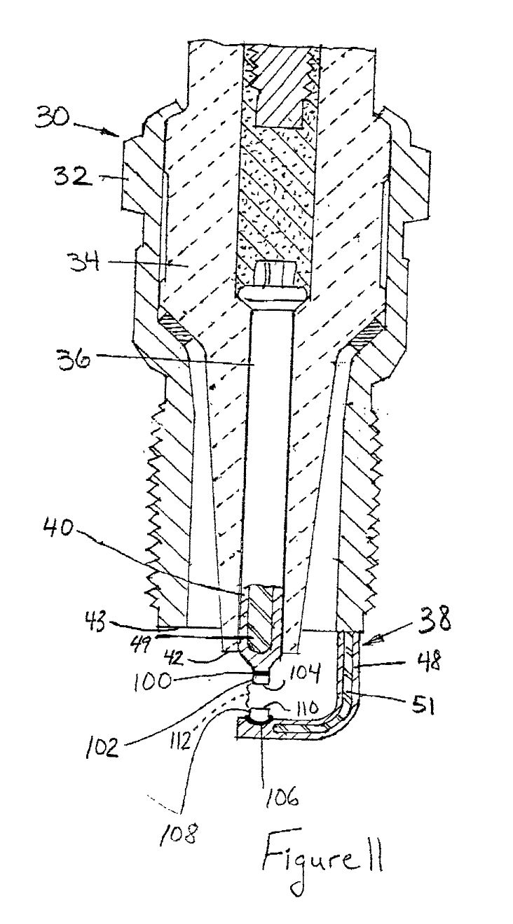

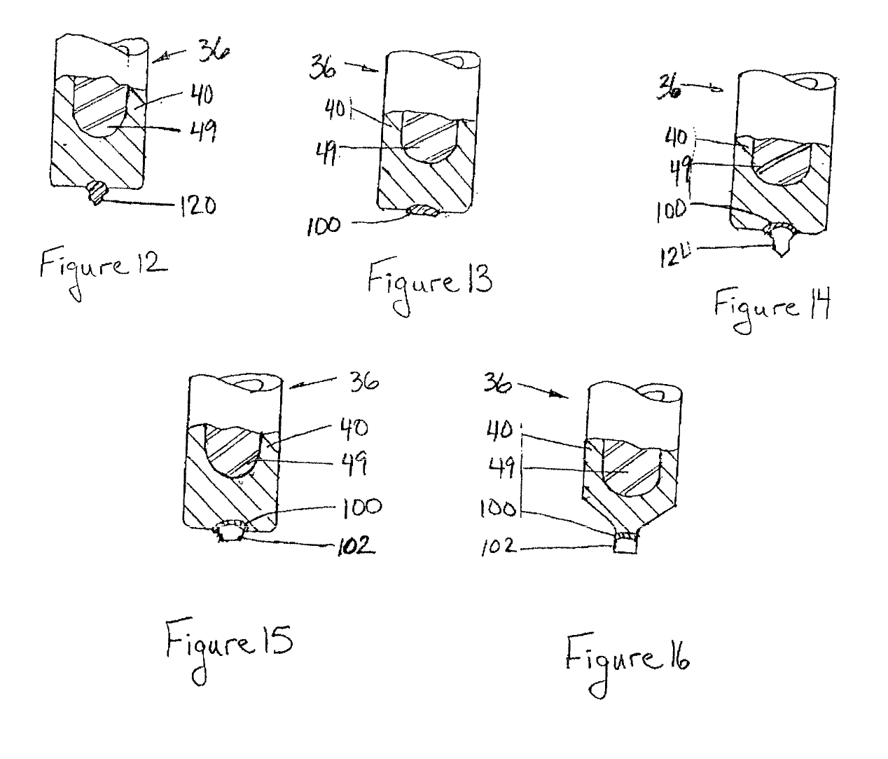

FIG. 11 illustrates an alternative embodiment of the thermal expansion divider layer utilized with a spark plug assembly. For purposes of illustration, the spark plug assembly of FIG. 11 comprises components similar to the spark plug assembly of FIG. 1. Spark plug assembly 30 further comprises a center electrode 40 that includes a thermal expansion divider layer 100. Affixed to the thermal expansion divider layer 100 is a firing tip 102 having a firing surface 104. The spark plug assembly 30 also further comprises a ground electrode 48 that includes a thermal expansion divider layer 106. Affixed to the thermal expansion divider layer 106 is a firing tip 108 having a firing surface 110. The firing tip 108 is coaxially aligned with the firing tip 102 of the center electrode 40, and located between the center and ground electrodes 40 and 48. The space formed between the firing tips 100 and 108 further defines a spark gap 112. FIGS. 12 through 16 can illustrate the fabrication of the center electrode's thermal expansion divider layer 100, and firing tip 102. A wire 120 can be held in place by any known technique, such as a collet, and the like, for resistance welding to the base of the center electrode 40. A continuous wire feeding and resistance welding procedure can weld the wire 120 comprising an electrically conductive electrode material, and having a diameter of up to about 2.00 mm, with up to about 1.00 mm preferred, and with about 0.40 mm to about 0.70 mm especially preferred, to the base of the center electrode (See FIG. 12). The resistance welded wire 120 can subsequently be cut to an appropriate length, and coined or flattened flush with the exterior surface of the center electrode's base to form a thermal expansion divider layer 100, having a diameter of up to about 2.00 mm, with up to about 1.00 preferred, and a geometry such as an annular shaped disc, or flat planar bar (See FIG. 13).

The wire can be held in place by any known technique, such as a collet, and the like, for resistance welding to the thermal expansion divider layer 100. The wire, comprising an electrically conductive material, and having a diameter of up to about 1.50 mm, with up to about 1.00 mm preferred, and about 0.45 mm to about 0.75 mm especially preferred. This wire can be welded to the thermal expansion divider layer 100 preferably using a continuous wire feeding and resistance welding procedure. The wire can subsequently be cut to an appropriate length to form an initial firing tip 124 for the center electrode 30 (See FIG. 14). The initial firing tip 124 can be coined or flattened, to create a firing tip 102 having mushroomed shaped surface, and a diameter of up to about 2.00 mm, with up to about 1.00 mm preferred, and up to about 0.90 mm especially preferred, and a height of up to about 1.50 mm, with up to about 1.00 mm preferred, up to about 0.75 mm especially preferred, and up to about 0.50 mm especially preferred (See FIG. 15). The firing tip, and a portion of the center electrode, can be sized, or narrowed, to a diameter of about 0.50 mm to about 1.00 mm, and a height of about 0.50 mm to about 1.00 mm (See FIG. 16). The dimensions of each component are ultimately dependent upon the overall size of the spark plug assembly, and therefore may vary substantially with each particular application.

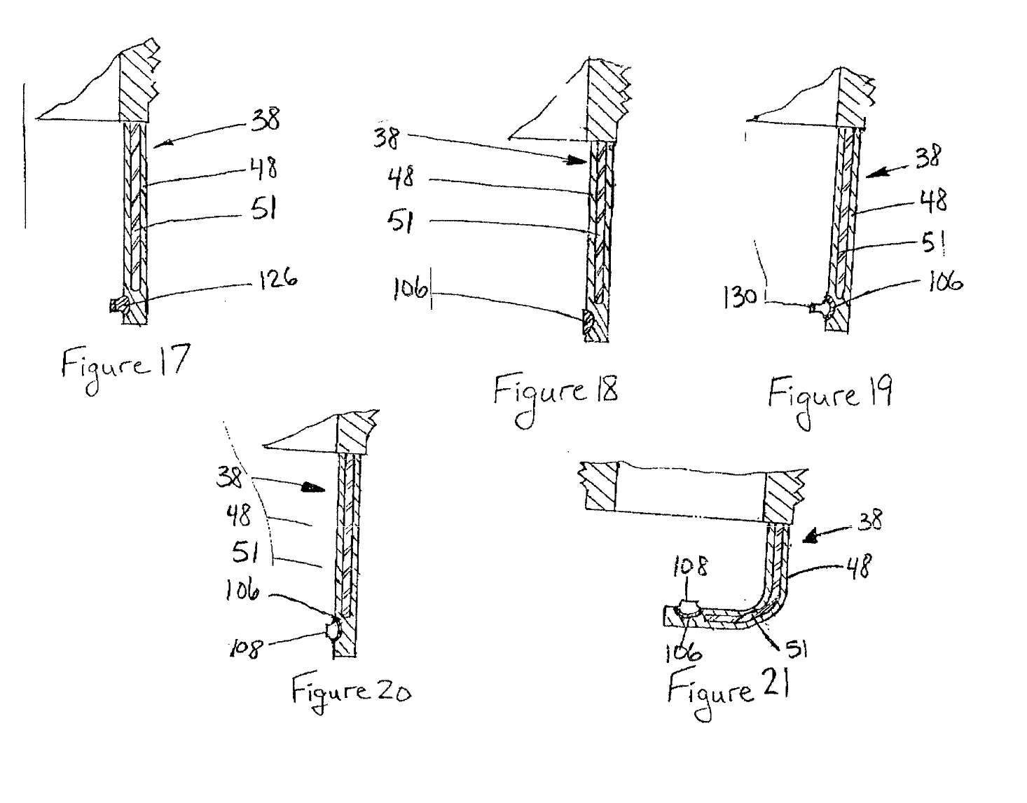

FIGS. 17 through 21 can illustrate the fabrication of the ground electrode's thermal expansion divider layer 106, and firing tip 108. A wire can be held in place for welding by any known technique, such as a collet, and the like, for resistance welding to the ground electrode 48. A continuous wire feeding and resistance welding procedure can weld the wire 126, comprising a electrically conductive electrode material, and having a diameter of up to about 1.00 mm, with about 0.40 mm to about 0.70 mm preferred, to the ground electrode 48 (See FIG. 17). The resistance welded metal wire 126 can subsequently be severed to an appropriate length, and coined, or flattened, to form a thermal expansion divider layer 106, having a diameter of up to about 2.00 mm, with up to about 1.00 mm preferred, and a geometry such as an annular shaped disc, or a flat, planar bar, flush, e.g., having a height of up to about 0.05 mm above the ground electrode's surface, with up to about 0.03 mm preferred, to the exterior surface of the ground electrode's base (See FIG. 18). A wire can be held in place by any known technique such as, a collet, and the like for resistance welding to the thermal expansion divider layer 106. The wire, compromising an electrically conductive material, and having a diameter of up to about 1.50 mm, with up to about 1.00 mm preferred, and about 0.45 mm to about 0.75 mm especially preferred, can be welded to the thermal expansion divider layer 106, preferably using a continuous wire feeding and resistance welding procedure. The metal wire can be subsequently cut to an appropriate length to form an initial firing tip 130 of the ground electrode 48 (See FIG. 19). The initial firing tip 130 can be coined, or flattened, to create a firing tip 108, having a mushroomed shaped surface, and a diameter of up to about 1.50 mm, with up to about 1.00 mm preferred, and up to about 0.90 mm especially preferred, and a height of up to about 1.00 mm, with up to about 0.75 mm preferred, and up to about 0.50 mm especially preferred (See FIGS. 20). The ground terminal 38 can be bent by any known technique sc, that the firing tip 108 is coaxially aligned with the firing tip 102, and located between the center and ground electrodes 40 and 48 (See FIG. 21). In addition, a spark gap 112 is also simultaneously formed. The dimensions of each component are ultimately dependent upon the overall size of the spark plug assembly, and therefore may vary substantially with each particular application.

The thermal expansion divider layer illustrated in FIG. 11 can preferably be utilized with engine applications having high swirl and excessive operating temperature conditions because the thin layer of thermal expansion divider material is shielded by the firing tip, which prevents the thermal expansion divider from corroding or blistering under high swirl and excessive operating temperature conditions at temperatures over about 850° C.

The methods for fabricating the thermal expansion divider layers are further illustrated by the following non-limiting examples.

### EXAMPLE 1

A Fe-15Cr-4Al disc, having a diameter of 2.50 mm, is resistance welded to the base of the center electrode to form a thermal expansion divider layer. The center electrode is made from INCONEL, 600, and has a silver or S copper core. The Fe-15Cr-4Al alloy and INCONEL 600 material meld during the resistance welding procedure to form a hybrid base electrode material comprising Fe15Cr-4Al and INCONEL 600 material. A platinum, iridium, platinum alloy or iridium alloy based wire, having a diameter of 0.50 mm, is secured to the base of the center electrode by a collet. The wire is then resistance welded to the thermal expansion divider layer. The resistance welded wire is severed to 0.70 mm in length, and coined to form a mushroomed shaped firing tip having a diameter of 1.00 mm, and a height of 0.50 mm. The firing tip, including a portion of the center electrode, is then sized to 0.75 mm in diameter, and 0.75 mm in height. This same procedure can be implemented to fabricate the thermal expansion divider layer, and firing tip, for the ground electrode, however; the firing tip does not undergo a sizing operation to narrow its diameter, and the ground electrode does not undergo a sizing operation to reduce its cross-sectional area.

### EXAMPLE 2

A Fe-15Cr-4Al wire is secured by a collet for resistance welding to the base of the center electrode. The Fe-15Cr-4Al wire, having a diameter of 0.50 mm, is resistance welded to a center electrode made from INCONEL 600, and having a silver or copper core. The wire is then resistance welded to the base of the center electrode. The resistance welded wire is severed to 0.70 mm, and coined to form a disc shaped thermal expansion divider layer having a diameter of 1.00 mm, and a height of 0.05 mm.

A platinum, iridium, platinum alloy or iridium alloy based wire, having a diameter of 0.50 mm, is secured by a collet for resistance welding to the base of the center electrode. The wire is then resistance welded to the thermal expansion divider layer. The resistance welded wire is severed to 0.70 mm in length, and coined to form a mushroomed shaped firing tip having a diameter of 1.00 mm, and a height of 0.50 mm. The firing tip, including a portion of the center electrode, is then sized to 0.75 mm in diameter, and 0.75 mm in height. This same procedure can be implemented to fabricate the thermal expansion divider layer, and firing tip, for the ground electrode, however; the firing tip does not undergo a sizing operation to narrow its diameter, and the ground electrode does not undergo a sizing operation to reduce its cross-sectional area.

The resulting spark plug electrode was tested for about 1,000 hours, which is at least 100,000 miles to up to 200,000 miles, using a 2.3 liter dynamometer engine. No significant increase in spark gap erosion or sparking voltage was noted as a result of the test. In addition, only partial oxidation occurred at both weld interfaces, that is at the electrode and thermal expansion divider layer weld interface, and the thermal expansion divider layer and firing tip weld interface.

In addition, an assembly comprising a firing tip resistance welded to an expansion divider layer was heated up to 830° C. and cooled to 300° C., under an atmosphere comprising an ethylene gas mixture, for up to 90,000 cycles (7 seconds per cycle). Under these conditions, the firing tip adhered to the thermal expansion divider layer.

The methods for fabricating the thermal expansion divider layers, and firing tips for a spark plug assembly, possess several advantages over conventional spark plug assemblies having thermal expansion divider layers. First, fabricating the firing tips using resistance welding prevents damaging the entire spark plug electrode. Due to differences in melting points, boiling points, and coefficients of thermal expansion values between the nickel alloys and noble metal alloys, as well as the diminutive size of the spark plug components, laser welding is more likely to damage the spark plug electrodes, than effectively weld the firing tip to the electrode.

Second, the thermal expansion divider layers of both embodiments serves as an intermediary material that substantially eliminates the peeling, cracking or spalling of the firing tip material. The thermal expansion divider layer has a coefficient of thermal expansion (CTE) value that divides the substantially large CTE value difference between the electrode material and firing tip material into two smaller CTE values, and provides a gradual transition in CTE values. The resulting combination of materials is less likely to experience premature thermal fatigue failure, such that the firing tip is less likely to peel, spall and/or crack and break off the thermal expansion divider layer.

Third, since the iron-based alloy of the thermal expansion divider layers is too difficult to extrude to form a thermally conductive core for either the center or ground electrodes, fabricating a thermal expansion divider layer for use with the ground and center electrodes is a preferable alternative. The thermal expansion divider layers possess a CTE value (about 13.7 um/m-° C. at approximately 900° C.) that falls substantially within the range of the CTE values for the electrode material (about 16.7 um/m-° C. at approximately 900° C.) and the firing tip materials (of about 10.0 to about 8.5 um/m-° C., respectively, at approximately 900° C.). If the firing tip material and electrode material are welded together without the thermal expansion divider layer, a substantially large difference in CTE values exists, e.g., about 16.7 um/m-° C. compared to about 10.0 or about 8.5 um/m-° C., respectively, between the electrode and firing tip materials. As the spark plug undergoes typical thermal cycling conditions, the firing tip material can peel, spall, and/or crack at the weld bond with the electrode. Consequently, the firing tip will fall off due to thermal fatigue.

In contrast, the thermal expansion divider layer CTE value substantially eliminates that substantially large CTE value difference between the electrode material and firing tip material. The thermal expansion divider layer CTE acts as an intermediary to divide the large CTE value to two smaller CTE values (about 16.7 um/m-° C. for the electrode material compared to about 13.7 um/m-° C. for the thermal expansion divider material; and about 13.7 um/m-° C. for the thermal expansion divider material compared to about 10.0 or about 8.5 um/m-° C. for the firing tip materials), and provide a gradual transition in CTE values. The resulting combination of materials is less likely to experience premature thermal fatigue failure, such that the firing tip is less likely to peel, spall and/or crack and break off the thermal expansion divider layer.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A spark plug assembly, comprising:
a shell;
an insulator body disposed within said shell;
a center terminal comprising a center electrode disposed within said insulator body;
a ground terminal comprising a ground electrode extending from said shell;
a resistance welded first and second thermal expansion divider layer disposed on said center electrode and said ground electrode; and
a resistance welded firing tip disposed on said first and second thermal expansion divider layers of said center electrode and said ground electrode, wherein said firing tips are coaxially aligned to define a spark gap.

2. The spark plug of claim 1, wherein said pair of thermal expansion divider layers further comprise an electrically conductive material selected from the group consisting of iron, chromium, aluminum, manganese, silicon, as well as alloys and combinations comprising at least one of the foregoing materials.

3. The spark plug of claim 1, further comprising a pair of thermal expansion divider layers further comprise an alloy comprising iron, up to about 15% by weight of chromium, and up to about 4% by weight of aluminum.

4. The spark plug of claim 1, wherein said thermal expansion divider layer has a coefficient of thermal expansion less than a coefficient of thermal expansion for said electrode, and greater than a coefficient of thermal expansion for said firing tip.

5. A method for fabricating a firing tip for a spark plug electrode, comprising:
resistance welding a thermal expansion divider layer to an electrode;
resistance welding a first electrically conductive wire to said thermal expansion divider layer;
cutting said first electrically conductive wire to form an initial tip; and
coining said initial firing tip to form a firing tip.

6. The method of claim 5, wherein said thermal expansion divider layer further comprises iron, up to about 15% by weight of chromium, and up to about 4% by weight of aluminum.

7. The method of claim 5, further comprising
resistance welding a second electrically conductive wire to an electrode;
cutting said second electrically conductive wire; and
coining said second electrically conductive wire to form said thermal expansion divider layer.

8. The method of claim 5, further comprising forming a thermal expansion divider layer having a coefficient of thermal expansion less than a coefficient of thermal expansion for said electrode, and greater than a coefficient of thermal expansion for said firing tip.

9. The method of claim 7, further comprising affixing said electrically conductive wire for resistance welding to an electrode using a collet.
